(19) United States
(12) Patent Application Publication
(10) Pub. No.: US 2024/0165607 A1
(43) Pub. Date: May 23, 2024

(54) SYSTEMS AND METHODS FOR PROCESSING FLUID CONTAINERS

(71) Applicant: DH Technologies Development Pte. Ltd., Singapore (SG)

(72) Inventors: Guy DIMAURO, Laguna Niguel, CA (US); Ronald FRANCK, Irvine, CA (US)

(73) Assignee: DH Technologies Development Pte. Ltd., Singapore (SG)

(21) Appl. No.: 18/551,248

(22) PCT Filed: Mar. 23, 2022
(86) PCT No.: PCT/IB2022/052678

§ 371 Date: Sep. 19, 2023

Related U.S. Application Data
(60) Provisional application No. 63/164,676, filed on Mar. 23, 2021.

(51) Int. Cl. B01L 3/00; B01L 9/00

(52) U.S. Cl. CPC B01L 3/5025; B01L 3/502715; B01L 9/527; B01L 2200/027

(57) ABSTRACT

A system and method for processing fluid containers, the system including a first tray holder to hold a first inlet tray and a first outlet tray, the first inlet tray including one or more reservoirs, and the first outlet tray including one or more cavities, a couplable upper member including a sealing surface, a moving mechanism to move the first tray holder in a first direction to bring at least one of the first inlet tray and the first outlet tray in contact with the sealing surface of the couplable upper member, and a floating plate at least one of between the first outlet tray and a top surface of the moving mechanism, and between the first inlet tray and the top surface of the moving mechanism, wherein the moving mechanism is configured to independently move the first inlet tray and the first outlet tray in the first direction.

### CROSS-REFERENCE TO RELATED APPLICATION

This application is being filed on Mar. 23, 2022, as a PCT International Patent Application and claims the benefit of and priority to U.S. Provisional Application No. 63/164,676, filed Mar. 23, 2021, which application is hereby incorporated herein by reference.

### BACKGROUND

Transferring fluids between fluid containers is challenging because of the leakage risks involved during the transfer process. Accordingly, various techniques are used to mitigate this challenge such as, e.g., sealing sample chambers, which may be costly, cumbersome, and/or inefficient, and may ultimately exhibit poor sealing properties during fluid transfer.

### BRIEF DESCRIPTION OF THE DRAWINGS

FIG. 1 is a block diagram illustrating a container processing system, in accordance with an example of the disclosure.

FIG. 2 illustrates a side view of container processing system, in accordance with an example of the disclosure.

FIGS. 3A and 3B illustrate opposite oblique angle views of a lift, inlet and outlet trays, and tray holder, in accordance with an example of the disclosure.

FIG. 4 is a flow diagram for filling containers using separately pressure-sealed trays, in accordance with an example of the disclosure.

FIGS. 5A-5C are perspective views of a fluid transfer system, in accordance with an example of the disclosure.

FIGS. 6A-6B are closer views of a fluid transfer system, in accordance with an example of the disclosure.

FIGS. 7A-7B are top views of tray holder(s), in accordance with an example of the disclosure.

FIGS. 8A-8D illustrate a tray locking mechanism, in accordance with various examples of the disclosure.

FIG. 9 is a perspective view of a fluid transfer cartridge, in accordance with an example of the disclosure.

FIG. 10 is a flowchart illustrating a method of fluid transfer, in accordance with an example of the disclosure.

FIG. 11 depicts a block diagram of a computing device an example of the disclosure.

### SUMMARY

In one aspect, the technology relates to a system for processing fluid containers, the system including a first tray holder configured to hold a first inlet tray and a first outlet tray, the first inlet tray including one or more reservoirs, and the first outlet tray including one or more cavities, a couplable upper member including a sealing surface, a moving mechanism configured to move the first tray holder in a first direction so as to bring at least one of the first inlet tray and the first outlet tray in contact with the sealing surface of the couplable upper member, and a floating plate at least one of between the first outlet tray and a top surface of the moving mechanism, and between the first inlet tray and the top surface of the moving mechanism, wherein the moving mechanism is configured to independently move the first inlet tray and the first outlet tray in the first direction.

In examples of the above aspect, the first tray holder is a movable tray holder; and the couplable upper member includes a cartridge including a plurality of capillaries. In other examples, the first direction is a vertical direction along an axis of the couplable upper member; at least one of the first inlet tray and the first outlet tray is lockable in place in the first tray holder; a pressure applied to the couplable upper member by the moving mechanism via the at least one of the first outlet tray and the first inlet tray and the floating plate located thereunder is independent from another pressure applied by the moving mechanism to the couplable upper member via the other one of the first outlet tray and the first inlet tray; a portion of the first tray holder that is underneath at least one of the first outlet tray and the first inlet tray includes a cutout so as to expose a bottom portion thereof; the moving mechanism is further configured to move the first tray holder in a horizontal direction; the moving mechanism includes at least two independent moving platforms, a first moving platform configured to move the first inlet tray against the bottom surface of the couplable upper member, and a second moving platform configured to move the first outlet tray against the bottom surface of the couplable upper member independently of the first moving platform.

In other examples of the above aspect, the system further includes a second tray holder configured to hold a second inlet tray and a second outlet tray, the second inlet tray being configured to contain one or more fluid reservoirs, and the second outlet tray including one or more cavities, wherein the moving mechanism is configured to move the second tray holder in the first direction. In another example, the second tray holder is a movable second tray holder; at least one of the second inlet tray and the second outlet tray is lockable in place in the second tray holder; the moving mechanism is configured to move at least one of the first tray holder and the second tray holder in a horizontal direction and in a vertical direction independently from each other; the first tray holder includes a sample plate, and the second tray holder includes a reagent plate. In another example, the moving mechanism includes at least two independent moving platforms, a first moving platform configured to move one of the first inlet tray and the second inlet tray against the bottom surface of the couplable upper member, and a second moving platform configured to move one of the first outlet tray and the second outlet tray against the bottom surface of the couplable upper member independently of the first moving platform; the couplable upper member includes a cartridge including a plurality of capillaries, the capillaries being in fluid contact with the reservoirs of the first inlet tray or the second inlet tray and with the cavities of the first outlet tray or the second outlet tray.

In another aspect, the technology relates to a method for processing fluid containers, the method including disposing a first tray holder against a bottom surface of a couplable upper member, the first tray holder holding a first inlet tray and a first outlet tray, the first inlet tray including a first fluid in one or more first reservoirs, the first outlet tray including a plurality of first cavities, and the couplable upper member including a plurality of capillaries, independently pressing the first inlet tray and the first outlet tray against the bottom surface of the couplable upper member such that the one or more first reservoirs are in fluid communication with a first end of the capillaries and the first cavities are in fluid communication with a second end of the capillaries, and applying a first force between the first reservoirs and the first cavities to urge at least a portion of the first fluid to transfer from the first reservoirs to the capillaries, wherein at least one of the first outlet tray and the first inlet tray includes a first floating plate thereunder, so that independently pressing the first outlet tray and the first inlet tray includes pressing the first floating plate against a bottom surface thereof to ensure sealing of an interface between the one of the first outlet tray and first inlet tray and the bottom surface of the couplable upper member.

In examples of the above aspect, moving the first tray holder includes moving the first tray holder in at least one of a horizontal direction and a vertical direction; the first tray holder holds the first inlet tray and the first outlet tray in a locked position; the method further includes transferring the first fluid from the capillaries to the first cavities by applying a second force between the capillaries and the first cavities. In other examples, the method further includes disposing a second tray holder against the bottom surface of the couplable upper member, the second tray holder holding a second inlet tray and a second outlet tray, the second inlet tray including a second fluid in one or more second reservoirs, the second outlet tray including a plurality of second cavities, independently pressing the second inlet tray and the second outlet tray against the bottom surface of the couplable upper member such that the second reservoirs are in fluid communication with a first end of the capillaries and the second cavities are in fluid communication with a second end of the capillaries, and applying a third force between the second reservoirs and the second cavities so that at least a portion of the second fluid transfers from the second reservoirs to the capillaries, wherein at least one of the second outlet tray and second inlet tray includes a second floating plate thereunder, so that independently pressing the second outlet tray and second inlet tray includes pressing the second flowing plate against a bottom surface thereof to ensure sealing of an interface between the one of the second outlet tray and second inlet tray and the bottom surface of the couplable upper member, and wherein the first tray holder and the second tray holder are contemporaneously and independently movable with respect to each other.

In examples of the above aspect, the method further includes transferring the second fluid from the capillaries to the second cavities by applying a fourth force between the capillaries and the second cavities; a portion of the first tray holder that is underneath at least one of the first outlet tray and the first inlet tray includes a cutout so as to expose a bottom portion thereof, and the first fluid is kept under thermal control via the cutout; the thermal control includes refrigeration of the first fluid.

These and other advantages, aspects and novel features of the present disclosure, as well as details of an illustrated embodiment thereof, will be more fully understood from the following description and drawings.

### DETAILED DESCRIPTION

The current state of product development, and scientific advancement in general, for example in the life sciences, is challenged by existing systems and methods which delay product and/or scientific development cycles. For example, sealing between containers during fluid transfer is challenged by the fact that fluid may be lost during transfer if the sealing is deficient. In addition, efficiency of the fluid transfer may be delayed by the requirement to clean the containers between each fluid transfer cycle.

Accordingly, a technical problem that exists is the ability to efficiently transfer fluid between containers while being able to clean the fluid containers between each fluid transfer cycle. One solution to this technical problem may include providing mechanisms and method of efficient fluid transfer as well as mechanisms and methods of cleaning of the fluid containers between cycles of fluid transfer.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present disclosure. Similarly, various spatial terms, such as “upper,” “lower,” “side,” and the like, may be used in distinguishing one element from another element in a relative manner. It should be understood, however, that components may be oriented in different manners, for example a lifting device may be turned sideways so that its “top” surface is facing horizontally and its “side” surface is facing vertically, without departing from the teachings of the present disclosure.

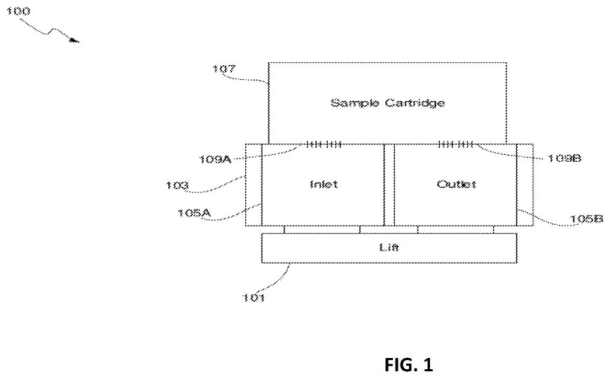

FIG. 1 is a block diagram illustrating a container processing system, in accordance with an example embodiment of the disclosure. Referring to FIG. 1, there is shown container processing system 100 comprising a lift 101, tray holder 103, inlet tray 105A, outlet tray 105B, and sample cartridge 107. Sealing interfaces 109A and 109B are also shown between the inlet and outlet trays 103 and 105, and the sample cartridge 107. As the inlet and outlet trays 103 and 105 may be several inches in length on a side, for example, if the inlet and outlet trays 103 and 105 had a common sealing surface, the seal length would be excessively long to ensure a proper seal, and the needed tolerances would be extremely difficult to meet.

The inlet tray 105A may comprise a one or more sample reservoirs for providing fluid samples to containers in the sample cartridge 107. In one example, the containers comprise containers such as capillaries, and the disclosure is not limited to such applications, but to any containers that receive samples which can include medical containers. Similarly, the outlet tray 105B may comprise a plurality of cavities for providing a force, pressure difference, or vacuum, to the containers in the sample cartridge 107 to force the fluid into the containers.

In an example embodiment of the disclosure, the sealing surfaces 109A and 109B may be separate for the inlet and outlet trays 105A and 105B with the trays being held in a single tray holder 103 and both being made against the same sample cartridge 107. In this embodiment, two individual trays that will be simultaneously pressurized may be pressed against a common plane. As it is very difficult to keep both trays parallel with one another within a tolerance that would guarantee reliable sealing, the two trays may be individual platforms that decrease the reliance on parallelism, while both trays still mostly move as one assembly when being pressed against the sealing surface. For example, the inlet tray 105A may be rigidly mounted to the tray holder 103 but the outlet tray 105B sits on a sub-plate within the tray holder 103 that may be lifted off the tray holder 103 and float independently of the tray holder 103 and inlet tray 105A. The top surface of the outlet tray 105B may also sit slightly below the top surface of the inlet tray 105A so that it has room to float when both trays are pressed against the cartridge 107. Two different mechanisms in the lift 101 press the trays, within the tray holder 103, against the cartridge 107. One mechanism may be centered below the inlet tray 105A, the other below the outlet tray 105B, as illustrated.

This structure makes pressure sealing easier where a pressure difference must be maintained between a plurality of pressure chambers that make contact with a common surface, and where the plurality of pressure chambers is within a single assembly. As the number of pressure chambers increases, so does the length of the seal. The longer the seal is, the more critical parallelism between the sealing surfaces becomes. When parallelism becomes more critical, the more difficult it becomes to keep parts and assemblies within a required tolerance. This disclosure provides a solution for eliminating the need for such precise parallelism.

Parallelism is important between parts that are pressed together to form a pressure seal. If the parts are not parallel enough, there will be gaps and pressure will leak. The issue of parallelism is amplified as the size of the seal increases. This disclosure mitigates this issue by decreasing the effective length of a pressure seal by breaking the seal up into multiple smaller seals that do not require such precise parallelism.

Conventional seals require very precise tolerances to parts. Such tolerances make parts expensive and difficult to work with. The structure of the present disclosure greatly relaxes these tolerances and makes manufacturing and assembly very simple and relatively inexpensive.

Pressure sealing becomes a unique issue because the length of a seal required for a cartridge with eight capillaries becomes exceptionally long. The longer the seal, the lower the parallel tolerance between the cartridge and the tray becomes. Without provisions to aid alignment, pressure sealing would be unreliable.

In the example of FIG. 1, the outlet tray 105B rests on a separate surface of the tray holder 103 from the inlet tray 105A, which allows the two trays to articulate independently from one another. This creates two medium-sized seals instead of one large seal, increasing the parallelism tolerance between the trays 105A/105B and the cartridge 107. The lift 101 comprises two independent lift structures for pressing the inlet tray 105A and outlet tray 105B against the sample cartridge 107 to form the sealing surfaces 109A and 109B. the inlet tray 105A and for the outlet tray 105B, which enables aligning features of the tray holder 103 to function properly.

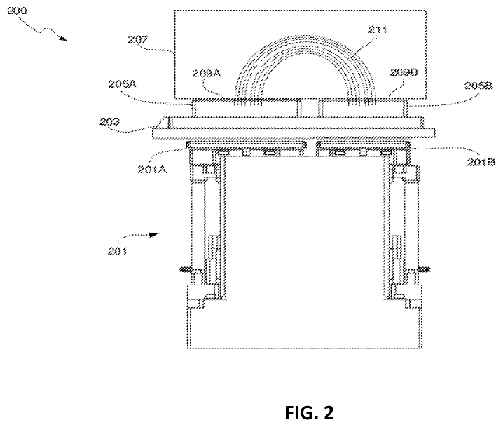

In operation, the container processing system 100 may provide sample material into containers in the sample cartridge 107. In an example scenario, the containers in the sample cartridge 107 may comprise capillaries that are coupled to the inlet and outlet trays 105A and 105B via nozzles or similar tubes. The lift 101 may apply pressure independently to the inlet tray 105A and outlet tray 105B so that each may be sealed against the sample cartridge 107 at the sealing surfaces 109A and 109B. The inlet side may be at a higher pressure and the outlet side under action of a force, pressure difference, or vacuum, for example, to create a force to pull liquid from the inlet tray 105A into the capillaries. Further details of the inlet and outlet trays, tray holder, lift, and sample cartridge are shown with respect to FIGS. 2-4.

FIG. 2 illustrates a side view of container processing system, in accordance with an example embodiment of the disclosure. Referring to FIG. 2, there is shown a container processing system 200 comprising lift 201, tray holder 203, inlet and outlet trays 205A and 205B, and sample cartridge 207. The lift 201 comprises independent lifting platforms 205A and 201B, each individually controllable for providing different pressure against the sealing surface, height, and orientation to the inlet and outlet trays 205A and 205B. For example, each lifting platform 205A and 201B may have the ability to adjust the angle of the top surface pressing against the corresponding inlet/outlet tray to optimize the pressure seal. Pressure may be monitored in one or more accessory ports in the inlet/outlet trays 205A/205B during the coupling process while adjusting lift pressure, height, and orientation.

FIG. 2 also shows example devices in the sample cartridge 207, which in this case are capillaries 211. When the inlet and outlet trays 205A and 205B are pressed against the sample cartridge 207, the capillaries 211 may be coupled to fluid reservoirs in the inlet tray 205A at one end and to outlet cavities in the outlet tray 205B at the other end. In the example shown, eight capillaries are situated in the cartridge 207, although the disclosure is not so limited, as any number may be utilized. The increasing number of capillaries results in a larger sealing surface, which illustrates the advantage of two independent sealing surfaces 209A and 209B with independent lifting platforms 205A and 201B. The sealing surfaces 209A and 209B may comprise the common surfaces in contact between the inlet and outlet trays 205A and 205B and the sample cartridge 207.

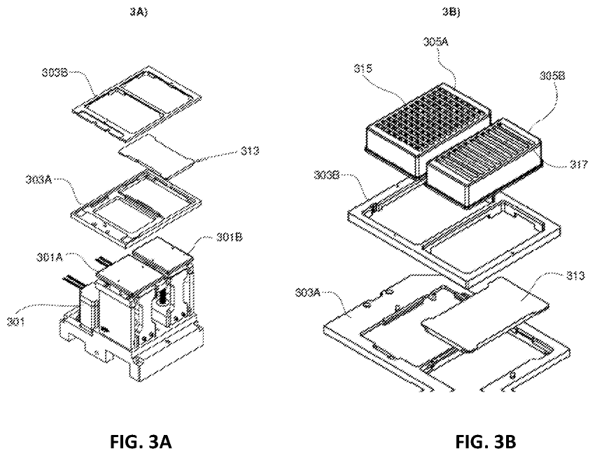

The tray holder 203 comprises a structural frame in which the inlet and outlet trays 205A and 205B may be situated, with the outlet tray 205B resting on a separate surface, such as a floating independent plate in the tray holder 203, as shown further with respect to FIG. 3.

In operation, the sample cartridge 207 with a plurality of capillaries 211 may be placed near the inlet and outlet trays 205A and 205B. The lifting platforms 205A and 201B may be independently configured to press the inlet tray 205A and outlet tray 205B, respectively, against the sample cartridge 207, such that sealing surfaces 209A and 209B result in a stable force such as a stable pressure difference or stable vacuum in the capillaries. A pressure difference may be applied between one or more reservoirs in the inlet tray 205A, each with fluid for a corresponding to a capillary 211, and a cavity or cavities in the outlet tray 205B to introduce the fluids into the capillaries 211. The pressure difference between inlet and outlet trays 205A and 205B causes a force which urges fluid to enter the capillaries. This force may be caused by a pressure difference that may be applied at the inlet tray 205, or may be a combination of positive pressure at the inlet tray 205A and negative pressure or vacuum at the outlet tray 205B. The pressure difference may be a few pounds per square inch (PSI), over 10 PSI, or over 20 PSI, for example. This may continue until the capillaries 211 are filled to an appropriate point, typically all the way to end of the capillary at the outlet tray 205B. The cartridge 207 may be removed from the inlet and outlet trays 205A and 205B, resulting in filled capillaries.

FIGS. 3A and 3B illustrate opposite oblique angle views of a lift, inlet and outlet trays, and tray holder, in accordance with an example embodiment of the disclosure. Referring to FIG. 3A, there is shown lift 301, tray holder sections 307A and 307A, and sub-plate 313. The tray holder sections 307A and 307B and sub-plate 313 represent the tray holder 103 and 203 described with respect to FIGS. 1 and 2. Sub-plate 313 comprises a separately configurable plate in the tray holder on which the outlet tray 305B may rest for independent configuration of pressure of the inlet ant outlet trays. FIG. 3A also shows the independent lift lifting platforms 305A and 301B that enable the separate configuration of pressing of the inlet and outlet trays. The lifting platforms 305A and 301B may be independently configured at different height, pressure (force), and orientation.

FIG. 3B shows an opposite angle view of the tray holder and inlet/outlet trays, illustrating how the inlet tray 305A may rest directly on the tray holder section 307A while the outlet tray 305B may rest on the sub-plate 313, enabling independent control of the pressure of the inlet and outlet trays against a sample cartridge, as shown with respect to FIG. 2. Openings in the tray holder section 307B are large enough that the inlet and outlet trays fit through and rest on the tray holder section 307A, for the inlet tray 305A, and on the sub-plate 313, for the outlet tray 305B. In an example scenario, the tray holder section 307B may slide to lock the inlet and outlet trays 305A and 305B in place.

The inlet tray 305A has one or more of fluid reservoirs 315, with twelve rows of eight reservoirs, corresponding to a cartridge with eight containers (e.g., capillaries), such that 96 different samples per cartridge may be processed with each of the eight capillaries processing twelve samples in this example, although other numbers are possible. Similarly, the outlet tray 305B comprises twelve cavities 317 that may be utilized to provide a lower pressure at the outlet end of the containers during filling and also drain any excess fluid from the capillaries during filling. The outlet tray 305B may instead comprise individual cavities as opposed to one for all eight containers in instances where different pressures may be desired for different containers. Again, the number of fluid reservoirs 315 and cavities 317, and the number of rows of reservoirs/cavities is merely an example, as any number may be utilized depending on equipment size and medical container/cartridge size. In some applications, the cavities 317 may also contain fluid.

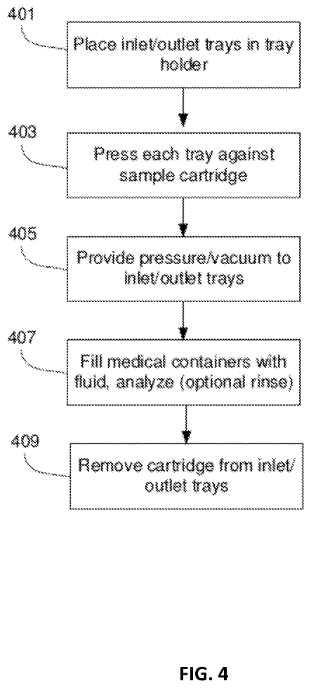

FIG. 4 is a flow diagram for filling containers using separately pressure-sealed trays, in accordance with an example embodiment of the disclosure. Referring to FIG. 4, the process begins in step 401 where an inlet tray with desired fluid in each reservoir is placed in the tray holder as well as an outlet tray in the tray holder, on sub-plate 313.

In step 403, the inlet ant outlet trays may be independently pressed against a sample cartridge using independent lift platforms, such that a different pressure seal is made for each tray, one between the inlet tray and the sample cartridge and another between the outlet tray and the sample cartridge. The sample cartridge may comprise a plurality of capillaries, for example, where the inlet side of the capillary is coupled to the inlet tray and the outlet side of the capillaries is coupled to the outlet tray.

In step 405, a pressure difference may be applied between fluid reservoirs in the inlet tray and the cavities in the outlet tray. In step 407, fluid is forced into the capillaries until they are filled to a desired level, and the force, pressure difference, or vacuum is stopped, followed by step 409, where the sample may be analyzed before the cartridge may be removed from the inlet and outlet trays. In another example scenario, a fluid may be utilized to rinse out the capillaries prior to filling and after analysis to enable filling with a second sample.

In another example scenario, the inlet and outlet trays may be equally pressurized, whether they both be ambient or at some other pressure. In this scenario, there is no fluid transfer, but there may be ion transfer. In the case of ion transfer, ions may be electrokinetically injected using a voltage differential, where there may be fluid in the outlet tray for voltage application. The buffer fluid provides a conductor for the voltage applied across the capillaries. In each tray, both the end of at least one capillary and an electrode may be submerged in buffer fluid, and current runs from the electrode, through the buffer, through the capillary, and then to an electrode submerged in buffer fluid with a matching capillary in the opposite tray. In other cases, while processing the samples, both trays may be pressurized to 20 PSI to suppress any bubbles that may otherwise generate from current-induced heat.

A system and/or method implemented in accordance with various aspects of the present disclosure, for example, provides an assembly for processing containers. The containers may comprise internal vessels, such as capillaries. The assembly may comprise an inlet tray comprising one or more fluid reservoirs; an outlet tray comprising one or more cavities; a lift mechanism; and a tray holder, which may be operable to receive the inlet and outlet trays. Containers may be filled with fluid by: independently pressing the inlet tray and the outlet tray against a cartridge containing the containers, such that the inlet and outlet trays have separate sealing surfaces with the cartridge; and providing a pressure difference between the fluid reservoirs in the inlet tray and the cavities in the outlet tray.

The containers may include internal vessels, and in one example may include capillaries. The inlet tray and the outlet tray may be operable to be moved independently of each other. The inlet tray rests on a bottom surface of the tray holder. The outlet tray may rest on a sub-plate within the tray holder. A top surface of the first tray may be below a top surface of the second tray. The inlet tray may comprise one or more rows of fluid reservoirs. The outlet tray may comprise rows of one or more cavities in each row. A lift with two independent lifting platforms may press the inlet and outlet trays against the cartridge. Each lifting platform may have an adjustable orientation and height independent of the other lifting platform.

Particular commercial implementations of the previously-described system and method are described below in the context of the following figures. The following figures utilize the technologies described above with additional features that provide the ability to efficiently clean the capillaries of the cartridge after each sample transfer and analysis cycle so as to allow subsequent sample transfers and analyses to take place in an efficient and timely manner. In addition, an added floating plate disposed under the outlet tray provides the ability to apply pressure to the outlet tray independently from the inlet tray, and thus to customize the applied pressures to achieve an efficient sealing of the interface between the cartridge and both the inlet tray and the outlet tray.

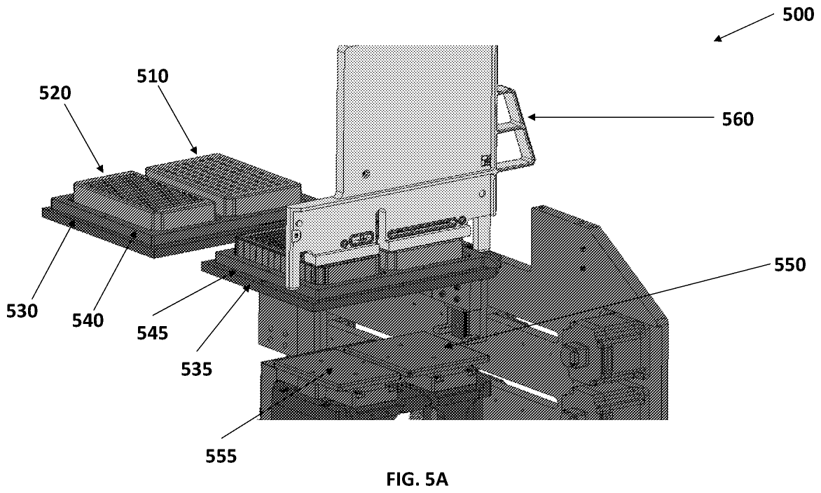

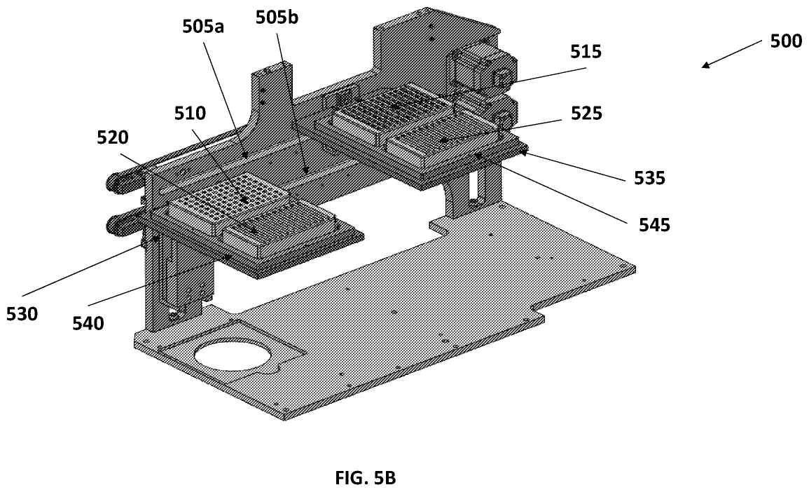

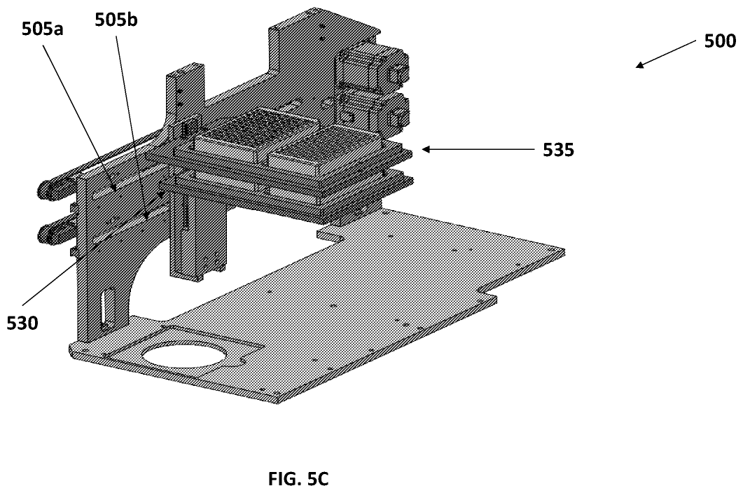

FIGS. 5A-5C are perspective views of a fluid transfer system, in accordance with an example of the disclosure. In FIG. 5A, the fluid transfer system 500 includes a tray holder 530 on which an inlet tray 510 and an outlet tray 520 are disposed, both the inlet tray 510 and the outlet tray 520 being positioned on a tray lock 540. In an example, the tray holder 530 is a sample plate. The tray lock 540, for example, is configured to lock both the inlet tray 510 and the outlet tray 520 in a fixed position on the tray holder 530. As an example, the inlet tray 510 and the outlet tray 520 are lockable in place in the tray holder 530. In FIG. 5A, the system 500 includes another tray holder 535 on which an inlet tray 515 and an outlet tray 525 are located (shown in FIG. 5B), both the inlet tray 515 and the outlet tray 525 being positioned on a tray lock 545. In an example, the tray holder 535 is a reagent plate. The tray lock 545, for example, is configured to lock both the inlet tray 515 and the outlet tray 525 in a fixed position on the tray holder 535. As an example, the inlet tray 515 and the outlet tray 525 are lockable in place in the tray holder 535. Accordingly, the transfer system 500 includes two (2) tray holders 530 and 535, each of the tray holders 530/535 including an inlet tray 510/515 and an outlet tray 520/525. In various aspects, both tray holders 530 and 535 are movable to place the inlet tray 510/515 and outlet tray 520/525 in direct contact with a surface of upper portion 560. For example, the couplable upper member 560 may be a cartridge configured to transfer fluids from the inlet tray 510/515 to the outlet tray 520/525. In an example, the couplable upper member 560 has a sealing surface. For example, the cartridge 560 may include a plurality of containers, vessels, or capillaries (not shown), that are configured to allow fluid transfer therein via, e.g., the application of a pressure differential between an inlet end and an outlet end of the capillaries. As an example, the capillaries are in fluid contact with the reservoirs of the first inlet tray 510 or the second inlet tray 515 and with the cavities of the first outlet tray 520 or the second outlet tray 525. For example, transferring the fluid from the reservoirs of the inlet tray 510/515 to the capillaries includes applying a force, vacuum or pressure difference between the reservoirs and the capillaries. Also, transferring the fluid from the capillaries to the cavities of the outlet tray 520/525 includes applying a force, vacuum or pressure difference between the capillaries and the cavities. In FIG. 5A, the system 500 also includes a moving mechanism including moving platforms or lifts 550 and 555, moving platform or lift 550 configured to lift the inlet tray 510/515 towards the cartridge 560, and moving platform or lift 555 configured to lift the outlet tray 520/525 towards the cartridge 560.

In an example operation of the system 500, the moving platforms or lifts 550 and 555 are independently controlled and are configured to apply different and independent pressures to the inlet tray 510/515 and the outlet tray 520/525, respectively. For example, moving platform or lift 550 may be centered below the inlet tray 510/515 (see FIG. 5B), and moving platform or lift 555 may be centered below the outlet tray 520/525.

In various examples, parallelism between parts that are pressed together to form a pressure seal such as, e.g., the inlet and outlet trays 510/515 and 520/525 pressed against the bottom surface of the couplable upper member or cartridge 560, is advantageous. In particular, if the inlet and outlet trays 510/515 and 520/525 are not sufficiently parallel when pressed against the couplable upper member or cartridge 560, there may be gaps therebetween, and the fluid being transferred between the inlet and outlet trays 510/515 and 520/525 and the capillaries in the couplable upper member or cartridge 560 may leak.

In the example of FIGS. 5A-5C, the inlet tray 510/515 may rest on a separate surface of the tray holder 530/535 from the outlet tray 520/525, which allows the two trays to articulate independently from one another. The lifting mechanism consists of two independent moving platforms 550 and 555 configured to press the inlet tray 510/515 and the outlet tray 520/525 against the cartridge 560 to form the sealing surface. In an example, the couplable upper member or cartridge 560 may include a plurality of capillaries that are coupled to the inlet tray 510/515 and the outlet tray 520/525 via nozzles or similar couplings (not shown). The moving platforms or lifts 550 and 555 may apply pressure independently to the inlet tray 510/515 and to the outlet tray 520/525 so that each may be sealed against the bottom surface of the couplable upper member or cartridge 560. In an example, the inlet side of capillaries of the couplable upper member or cartridge 560 may be submitted to a higher pressure than the outlet side thereof, for example, in order to create a force in the form of a pressure difference or relative vacuum to pull fluid from the inlet tray 510/515 into the capillaries and onto the outlet tray 520/525.

FIG. 5B illustrates a different perspective of the fluid transfer system 500, according to various aspects. In FIG. 5B, the tray holder 530 is configured to be movable along railing 505b, and the tray holder 535 is configured to be movable along railing 505a. In an example, railings 505a and 505b are parallel to each other with railing 505b being on a lower plane than railing 505a. Accordingly, in FIG. 5B, the moving rails 505a/505b are configured to allow movement of tray holders 530 and 535 along parallel longitudinal directions so that they can be positioned at a distance from each other, as illustrated in FIGS. 5A and 5B, or positioned directly above each other, as illustrated in FIG. 5C.

FIG. 5C illustrates another perspective of the fluid transfer system 500, according to various aspects. FIG. 5C illustrates both tray holders 530 and 535 in a storage or rest configuration. In FIG. 5C, the tray holders 530 and 535 are stacked over each other, in a direction perpendicular to surfaces thereof, the tray holders 530 and 535 being coupled in a moving configuration to the rails 505b and 505a, respectively. The configuration illustrated in FIG. 5C is typically achieved when the system 500 is at rest and no fluid transfer operation is taking place.

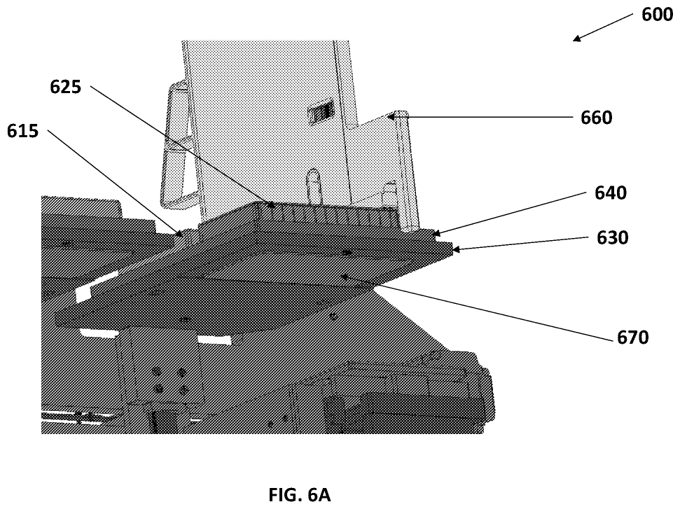

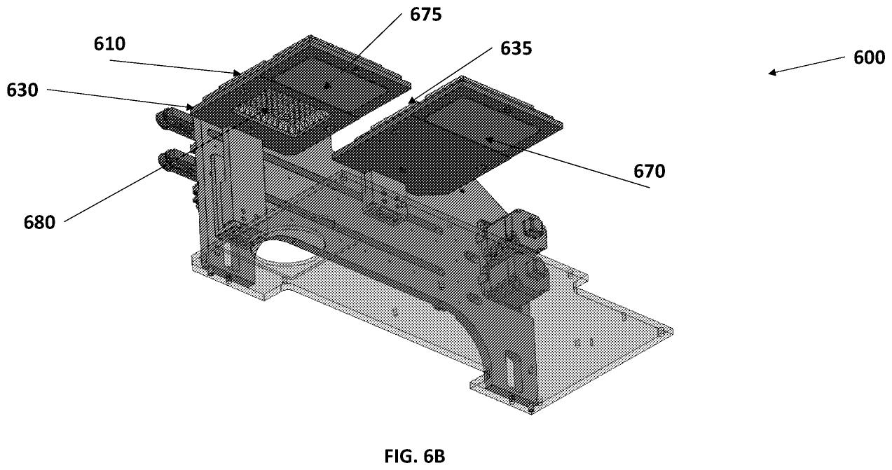

FIGS. 6A-6B are closer views of a fluid transfer system, in accordance with an example of the disclosure. In FIG. 6A, the fluid transfer system 600 includes a tray holder 630 on which a tray lock 640 is positioned, the tray lock 640 including tray holders configured to be positioned against the bottom surface of a couplable upper member or cartridge 660. In various aspects, the top surface of the outlet tray 625 may sit slightly below the top surface of the inlet tray 615 so that it has sufficient room to float when both trays are pressed against the couplable upper member or cartridge 660 so as to provide sufficient sealing efficiency to the couplable upper member of cartridge 660. For example, a floating plate 670 may be disposed under the tray holder 630 that supports the outlet tray 625. In various aspects, the presence of the floating plate may allow to differentially and independently adjust the location of the inlet tray 615 and outlet tray 625 under the couplable upper member or cartridge 660 so as to ensure an efficient sealing of the interface between the inlet tray 615/outlet tray 625 and the bottom surface of the couplable upper member or cartridge 660. Although the examples above describe a floating plate 670 that supports the outlet tray 625, examples of the present disclosure may also include a floating plate that supports the inlet tray 615. In an example, the pressure applied to the couplable upper member or cartridge 660 by the moving mechanism via one of the first outlet tray 625 and the first inlet tray 615, and via the floating plate 670 located under the one of the first outlet tray 625 and the first inlet tray 615, is independent from another pressure applied by the moving mechanism to the couplable upper member or cartridge 660 via the other one of the first outlet tray 625 and the first inlet tray 615.

Referring back to FIG. 5A, in operation, when the inlet and outlet trays 510/520 are moved to be in contact with the couplable upper member or cartridge 560 so that a fluid sample can transfer from the inlet tray 510 to capillaries of the cartridge 560 and out to the outlet tray 520, no or substantially no leakage of fluid transfer may take place because the inlet tray 510 and the outlet tray 520 are independently pressed against the bottom surface of the cartridge 560. As illustrated in FIG. 6A, the floating plate 670 allows to better align the outlet tray 625 so as to ensure a sufficient sealing fit with the couplable upper member or cartridge 660. Referring back to FIG. 5A, when tray holder 535, which may include a reagent, is moved to be in contact with a bottom surface of the cartridge 560 so as to circulate reagent in the capillaries of the cartridge 560, the reagent may be able to transfer from the inlet and outlet trays of the tray holder 535 into the capillaries of the cartridge 560, and back out of the capillaries of the cartridge 560, so that the reagent may clean the capillaries, e.g., after a cycle of fluid sample transfer from the tray holder 530 into the cartridge 560.

FIG. 6B is a bottom view of the fluid transfer system 600, showing floating plates 670 and 675 for the tray holders 630 and 635, respectively. In various aspects, the inlet tray 610 of the fluid tray holder 630, which is configured to hold the fluid sample, includes a cutout 680 in a bottom portion thereof. For example, the cutout 680 may allow for heat treating the inlet tray 610 and the fluid sample held therein. In an aspect, the cutout 680 allows for keeping the fluid sample held in the inlet tray 610 refrigerated at a desired temperature. As another example, the tray holder 635, which is configured to hold the reagent, may not include a cutout. As yet another example, instead of the inlet tray 610, the outlet tray of the fluid tray holder 630, although not shown in the drawings, may include a cutout in a bottom portion thereof.

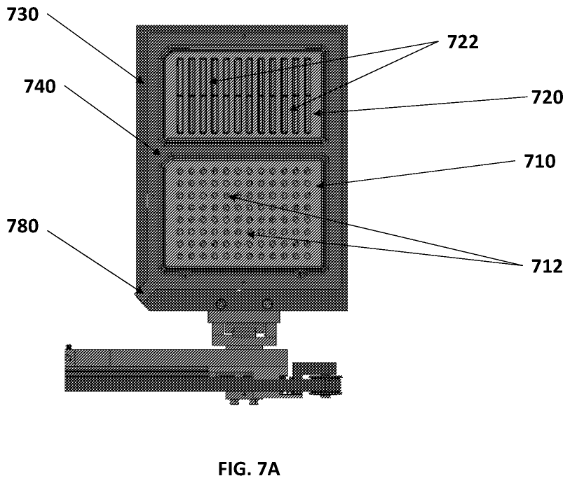

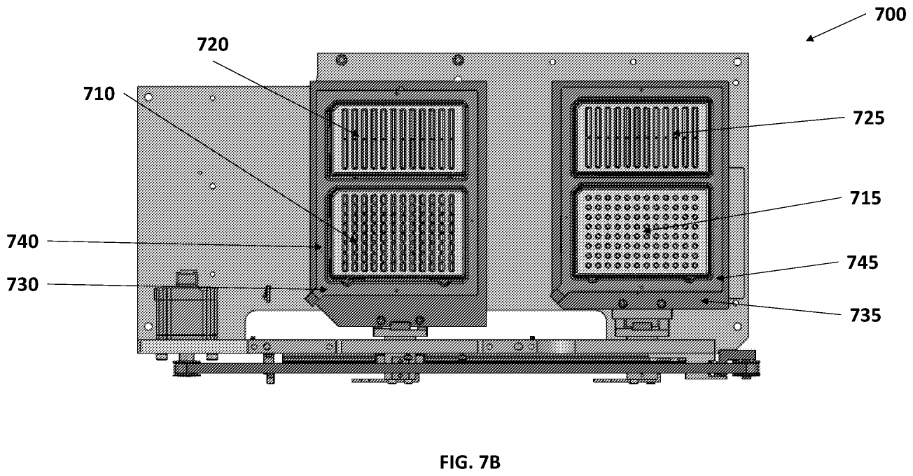

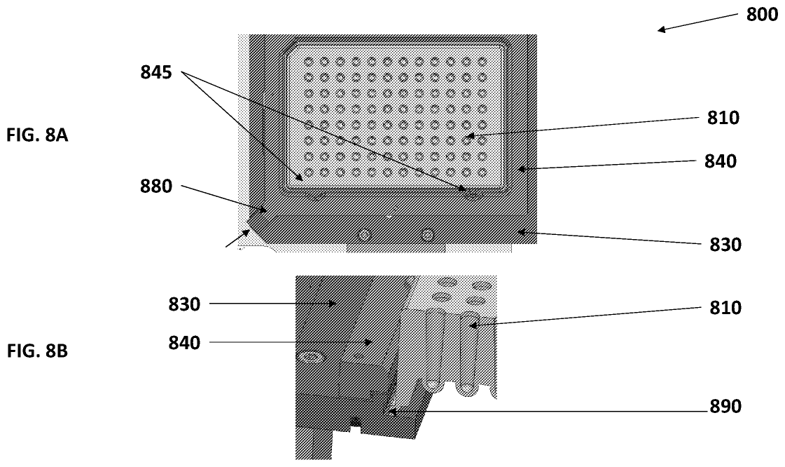

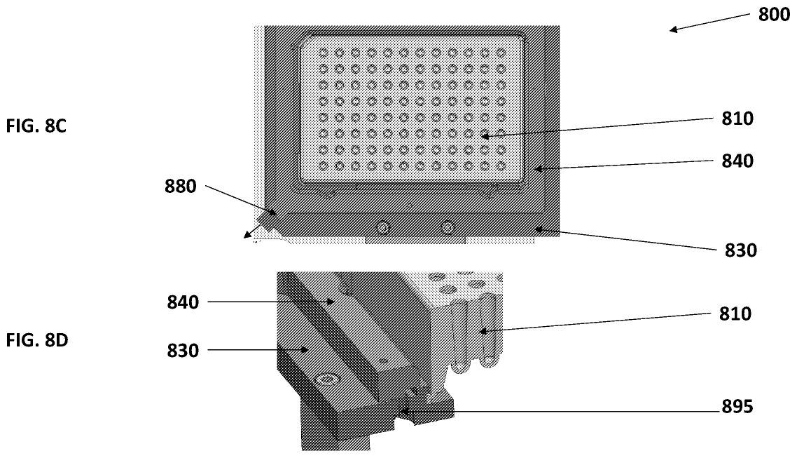

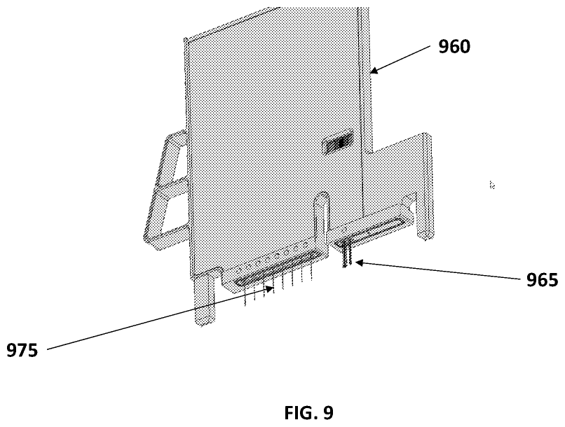

FIGS. 7A-7B are top views of a tray holder, in accordance with an example of the disclosure. FIG. 7A is a top view of a tray holder 730 on which an inlet tray 710 and an outlet tray 720 are disposed, both the inlet tray 710 and the outlet tray 720 being positioned on a tray lock 740. In an example, the tray lock 740 includes a locking tab 780 configured to slide in and out of a locking position, as further discussed below with respect to FIGS. 8A-8B. FIG. 7B illustrates the fluid transfer system 700, according to various aspects. For example, the fluid transfer system 700 includes the tray holder 730 on which the inlet tray 710 and the outlet tray 720 are disposed, both the inlet tray 710 and the outlet tray 720 being positioned on tray lock 740. The fluid transfer system 700 also includes another tray holder 735 on which an inlet tray 715 and an outlet tray 725 are disposed, both the inlet tray 715 and the outlet tray 725 being positioned on a tray lock 745. Both tray holders 730 and 735 may be located on the same fluid transfer system 700, and may both be configured to transfer fluid with a cartridge (not shown), such as the cartridge 560 illustrated in FIG. 5A. In an example, one of the tray holders 730 and 735 may be configured to hold fluid samples, and the other of the tray holders 730 and 735 may be configured to hold reagents designed to clean the capillaries of a cartridge such as, e.g., the cartridge 560 illustrated in FIG. 5A.

In the examples illustrated in FIGS. 7A-7B, the inlet tray 710/715 has one or more fluid reservoirs 712, with twelve rows of eight reservoirs. As such, any upper portion or cartridge (not shown) configured to transfer fluid form the inlet tray 710/715, may be able to have eight containers (e.g., capillaries), such that 96 different samples per cartridge may be processed, with each of the eight capillaries processing twelve samples. Other inlet trays and cartridges may have different numbers of reservoirs and capillaries. Similarly, the example outlet tray 720/725 illustrated in FIGS. 7A-7B includes twelve cavities 722 that may be utilized to provide a force, pressure difference, or vacuum effect at the outlet end of the capillaries in order to fill the capillaries as well as drain the fluid out of the capillaries. In other examples, the outlet tray 720/725 illustrated in FIG. 7B may include cavities individually coupled to each capillary to apply different pressures to different capillaries. In another example, the number of fluid reservoirs 712 and cavities 722 is merely an example, as any number may be utilized depending on equipment size and medical container/cartridge size. In some applications, the cavities 722 may also contain a fluid sample. In other examples, the fluid reservoirs 712 may include a reagent configured to clean, or remove any trace of, a fluid sample previously held in the reservoirs 712. Accordingly, by transferring a reagent from the fluid reservoirs 712 of the inlet tray 710/715 into the cartridge and back out into the cavities 722 of the outlet tray 720/725, it may be possible to clean the entire system of previously transferred liquid sample.

FIGS. 8A-8D illustrate a tray locking mechanism, in accordance with various examples of the disclosure. FIG. 8A illustrates a fluid transfer system 800 that includes a tray holder 830 on which an inlet tray 810 is located, the inlet tray 810 being disposed on a tray lock 840. In an example, the tray lock 840 includes placement tabs 845 configured to help locate the inlet tray 810 on tray lock 840. As an example, the shape and size of the placement tabs 845 may be configured so that third-party inlet trays, or otherwise unapproved inlet trays, may not be able to be effectively placed on the tray holder 830. In another example, the tray lock 840 illustrated in FIGS. 8A-8B is in an unlocked position. For example, in FIG. 8A, the locking tab 880 is in a retracted position, as illustrated by the arrow. As a result, as illustrated in FIG. 8B, the inlet tray 810 is moved away from the lip 890 of the tray holder 830 via, e.g., a cam roller (not shown), thus creating a clearance between the tray lip 890 of the tray holder 830 and the inlet tray 810. Because the locking tab 880 is in a retracted position, the inlet tray 810 and the tray lock 840 are not engaged, and the tray locking mechanism is in an unlocked configuration. In the unlocked configuration, the tray holder 830 can be easily removed from the fluid transfer system 800. The above discussion describes an inlet tray 810 being in an unlocked configuration, and the same may be applied to the locking configuration of an outlet tray (not shown).

FIGS. 8C-8D illustrate a tray locking mechanism in a locked configuration. In FIG. 8C, the locking tab 880 is in an expanded position, as illustrated by the arrow. In FIG. 8D, the inlet tray 810 is engaged with the lip 895 of the tray holder 830. As the locking tab 880 is in an expanded position, as indicated by the arrow directed away from the inlet tray 810, the movable tray lock 840 pushes the inlet tray 810 under a locking flange (not shown) so that the lip 895 of the tray holder 830 engages the edge of the inlet tray 810, and as a result the inlet tray 810 and the tray lock 840 become engaged and locked. As a result of the engagement of the inlet tray 810 and the tray lock 840, the tray locking mechanism is in a locked configuration. The above discussion describes an inlet tray 810 being in a locked configuration, and the same may be applied to the locking configuration of an outlet tray (not shown).

FIG. 9 is a perspective view of a fluid transfer cartridge, in accordance with example aspects. In various aspects, the cartridge 960 includes a plurality of capillaries (not shown) that extend outside of the cartridge in the form of inlet capillaries 975 and outlet capillaries 965. In an example, the inlet capillaries 975 are configured to be coupled to an inlet tray such as, e.g., the inlet tray 710 discussed above, and the outlet capillaries 965 are configured to be coupled to an outlet tray such as, e.g., the outlet tray 720 discussed above. In another example, the pressures applied to the inlet tray and to the outlet tray against the cartridge 960 are independently controlled, e.g., the pressure applied to the inlet tray may be different from the pressure applied to the outlet tray so as to ensure efficient sealing between the inlet and outlet trays and the cartridge and reduce or avoid any fluid leakage therefrom. In other examples, the cartridge 960 may also include seals around capillaries 975 and 965 in order to avoid or reduce fluid loss during the fluid transfer between the cartridge 960 and the inlet or outlet trays.

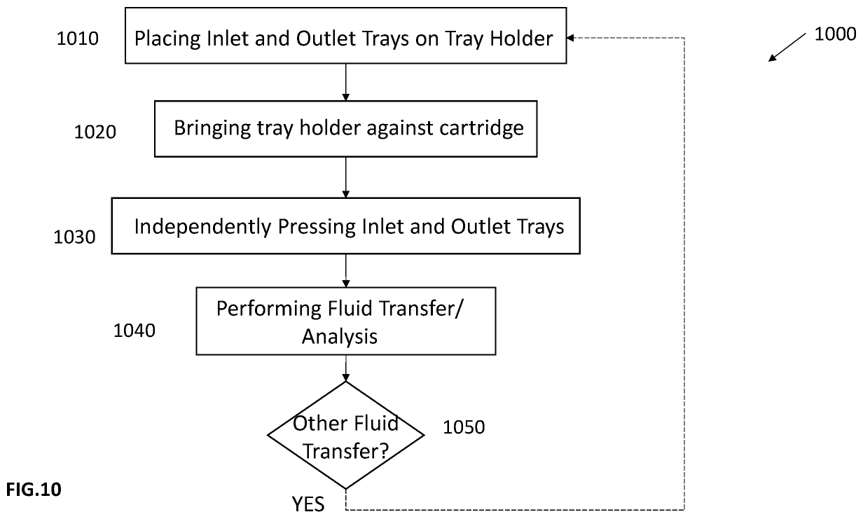

FIG. 10 is a flowchart illustrating a method of fluid transfer, in accordance with example aspects. In FIG. 10, the method 1000 includes a plurality of operations 1010-1050 further discussed below. For the sole purpose of convenience, method 1000 is described through use of at least the example system 1100 described below in combination with the fluid transfer system discussed above. However, it is appreciated that the method 1000 may be performed by any suitable system. In FIG. 10, operation 1010 includes placing an inlet tray and an outlet tray in a tray holder. With reference to FIGS. 5A-5C discussed above, the inlet tray may be inlet tray 510, the outlet tray may be outlet tray 520, and the tray holder may be tray holder 530. For example, the inlet tray may hold a fluid in one or more reservoirs, and the outlet tray may hold the fluid in a plurality of cavities. The inlet tray and outlet tray may be placed in the tray holder in a locked position, or in an unlocked position. In an unlocked position, the inlet tray and outlet tray may be removed from the tray holder without significant effort, and in a locked position, the inlet tray and outlet tray may be fixed in place in the tray holder.

During operation 1020, the inlet tray and outlet tray, placed in a locked position in the tray holder, are brought against a bottom surface of a couplable upper member or cartridge via the application of a pressure directed towards the bottom surface of the couplable upper member or cartridge. For example, the couplable upper member or cartridge may be similar to the cartridge 960 discussed above. In various aspects, the inlet tray and the outlet tray may be brought against the bottom portion of the cartridge along a vertical direction, e.g., a direction perpendicular to the longitudinal direction of the tray holder. In an example, the inlet tray and the outlet tray may also be moved in a horizontal direction, e.g., a direction parallel to a longitudinal direction of the tray holder.

During operation 1030, the inlet tray and the outlet tray are pressed against the bottom surface of the couplable upper member or cartridge. For example, the inlet tray and the outlet tray are pressed against the bottom surface of the couplable upper member or cartridge so as to ensure that fluid transfer between each of the inlet tray and the outlet tray and the cartridge may take place without any amount, or without any significant amount, of fluid leaking out of the inlet and outlet trays or out of the cartridge. For example, each of the inlet tray and the outlet tray may be subjected to independently controlled pressures when being brought against the bottom surface of the couplable upper member or cartridge. For example, the pressure to which the inlet tray is subjected may be smaller, or greater, than the pressure to which the outlet tray is subjected. Each pressure applied may be tailored so as to ensure a substantially hermetic fit between the trays and, e.g., the capillaries of the cartridge such as the capillaries 965 and 975 discussed above. In the case of the outlet tray, a floating plate such as, e.g., the floating plate 670 discussed above with respect to FIG. 6A, may be provided under the outlet tray so as to also ensure that sufficient pressure is applied to the cartridge, or to the capillaries of the cartridge, so as to ensure efficient transfer of fluid from the cartridge into the outlet tray. Accordingly, during operation 1030, the inlet and outlet trays may be independently pressed against a couplable upper member or cartridge using independent lift platforms, such that a different pressure seal is made for each tray, one pressure seal between the inlet tray and the sample cartridge, and another pressure seal between the outlet tray and the sample cartridge.

During operation 1040, once both the inlet tray and the outlet tray are pressed against the bottom surface of the cartridge so as to ensure efficient fluid transfer therebetween, the fluid present in the inlet tray may be efficiently transferred to the cartridge, and the fluid from the cartridge may be efficiently transferred to the outlet tray. For example, a force, pressure difference, or vacuum may be created between the fluid reservoirs in the inlet tray and the cavities in the outlet tray. Accordingly, fluid may be forced from the inlet tray into the capillaries of the cartridge until the capillaries are filled to a desired level. When the capillaries are filled, the force, pressure difference, or vacuum may be removed and the fluid may be analyzed, e.g., in the cartridge. In an example, the cartridge may be removed from the inlet tray in order to perform the analysis. When the analysis is performed, the outlet tray may be brought in contact with the cartridge, and the fluid may be transferred out to the outlet tray, also via the application of a force, pressure difference, or vacuum.

In another example of operation 1040, the inlet and outlet trays may be equally pressurized, whether they both be at ambient pressure or at another pressure. In this case, although no fluid transfer may take place, an ion transfer may take place between the inlet tray and the capillaries of the cartridge. In the case of ion transfer, ions may be electrokinetically injected using a voltage differential. A buffer fluid may be added to provide a conductor for the voltage applied across the capillaries between inlet tray and outlet tray. In each tray, both the end of at least one capillary and an electrode may be submerged in the buffer fluid, and a current may run from the electrode, through the buffer, through the capillary, and then to an electrode submerged in the buffer fluid with a matching capillary in the opposite tray. In other cases, both the inlet tray and the outlet tray may be pressurized to a desired pressure such as, e.g., 20 PSI, in order to suppress any bubbles that may otherwise generate from current-induced heat.

In various aspects, after a cycle of analysis of a given fluid sample is completed, and before another analysis of a different fluid sample is started, the capillaries of the cartridge may have to be cleaned to remove any trace of the fluid sample. Accordingly, it may be determined during operation 1050 that another fluid transfer is to be performed, where a liquid reagent is utilized to rinse out the fluid sample from the capillaries. In another example, it may also be determined during operation 1050 that after cleaning of the capillaries, another fluid sample is to be transferred in the cartridge and analyzed. With reference to FIGS. 5A-5B, once the sample fluid is transferred to the cartridge via tray holder 530 and inlet/outlet trays 510/520 and analyzed, as described with respect to operations 1010-1040 discussed above, the tray holder 530 may be moved away from the cartridge via railing 505b, and another tray holder, e.g., tray holder 535, may be brought against the cartridge where operations 1010-1040 are started anew. Specifically, and with reference to FIG. 5B, tray holder 535 may hold a cleaning reagent in the cavities of the inlet tray 515, and may be brought against the cartridge via the railing 505a. Accordingly, when the inlet tray is coupled to the cartridge, the reagent may transfer from the inlet tray into the capillaries of the cartridge, and then back out to the outlet tray, via the application of a force, pressure difference, or vacuum. In various aspects, transferring the reagent into the cartridge and back out of the cartridge may ensure that the capillaries are clean of fluid sample, and that any traces of the sample that was previously present in the capillaries may be removed so as to allow the system to receive and analyze another sample, and start operations 1010-1040 anew. When it is determined, during operation 1050, that no other tray fluid is to be transferred to the cartridge, then operation ends.

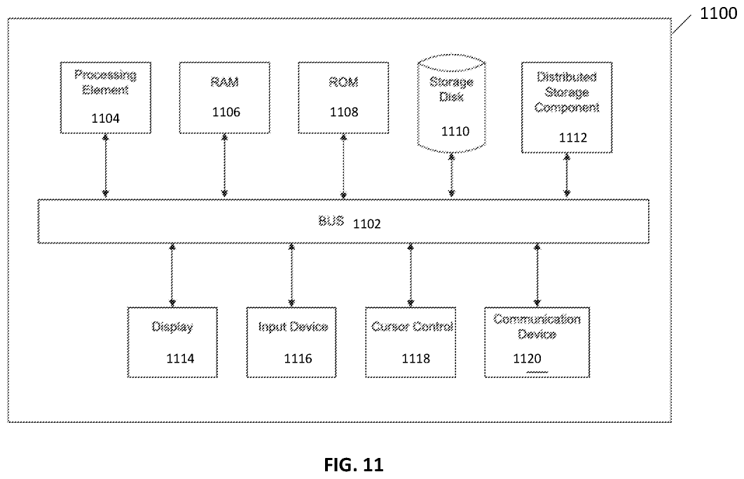

FIG. 11 depicts a block diagram of a computing device, according to various aspects. In the illustrated example, the computing device 1100 may include a bus 1102 or other communication mechanism of similar function for communicating information, and at least one processing element 1104 (collectively referred to as processing element 1104) coupled with bus 1102 for processing information. As will be appreciated by those skilled in the art, the processing element 1104 may include a plurality of processing elements or cores, which may be packaged as a single processor or in a distributed arrangement. Furthermore, a plurality of virtual processing elements 1104 may be included in the computing device 1100 to provide the control or management operations for the fluid transfer systems 100-800 or the method 1000 illustrated above.

The computing device 1100 may also include one or more volatile memory(ies) 1106, which can for example include random access memory(ies) (RAM) or other dynamic memory component(s), coupled to one or more busses 1102 for use by the at least one processing element 1104. Computing device 1100 may further include static, non-volatile memory(ies) 1108, such as read only memory (ROM) or other static memory components, coupled to busses 1102 for storing information and instructions for use by the at least one processing element 1104. A storage component 1110, such as a storage disk or storage memory, may be provided for storing information and instructions for use by the at least one processing element 1104. As will be appreciated, the computing device 1100 may include a distributed storage component 1112, such as a networked disk or other storage resource available to the computing device 1100.

The computing device 1100 may be coupled to one or more displays 1114 for displaying information to a user. Optional user input device(s) 1116, such as a keyboard and/or touchscreen, may be coupled to Bus 1102 for communicating information and command selections to the at least one processing element 1104. An optional cursor control or graphical input device 1118, such as a mouse, a trackball or cursor direction keys for communicating graphical user interface information and command selections to the at least one processing element. The computing device 1100 may further include an input/output (I/O) component, such as a serial connection, digital connection, network connection, or other input/output component for allowing intercommunication with other computing components and the various components of the fluid transfer systems 100-800 or the method 1000 illustrated above.

In various embodiments, computing device 1100 can be connected to one or more other computer systems via a network to form a networked system. Such networks can for example include one or more private networks or public networks, such as the Internet. In the networked system, one or more computer systems can store and serve the data to other computer systems. The one or more computer systems that store and serve the data can be referred to as servers or the cloud in a cloud computing scenario. The one or more computer systems can include one or more web servers, for example. The other computer systems that send and receive data to and from the servers or the cloud can be referred to as client or cloud devices, for example. Various operations of the fluid transfer systems 100-800 or the method 1000 illustrated above may be supported by operation of the distributed computing systems.

The computing device 1100 may be operative to control operation of the components of the fluid transfer systems 100-800 or the method 1000 illustrated above through a communication device such as, e.g., communication device 1120, and to handle data provided from the data sources as discussed above with respect to the fluid transfer systems 100-800 or the method 1000. In some examples, analysis results are provided by the computing device 1100 in response to the at least one processing element 1104 executing instructions contained in memory 1106 or 1108 and performing operations on the received data items. Execution of instructions contained in memory 1106 and/or 1108 by the at least one processing element 1104 can render the fluid transfer systems 100-800 or the method 1000 operative to perform methods described herein.

The term “computer-readable medium” as used herein refers to any media that participates in providing instructions to the processing element 1104 for execution. Such a medium may take many forms, including but not limited to, non-volatile media, volatile media, and transmission media. Non-volatile media includes, for example, optical or magnetic disks, such as disk storage 1110. Volatile media includes dynamic memory, such as memory 1106. Transmission media includes coaxial cables, copper wire, and fiber optics, including the wires that include bus 1102.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to the processing element 1104 for execution. For example, the instructions may initially be carried on the magnetic disk of a remote computer. The remote computer can load the instructions into its dynamic memory and send the instructions over a telephone line using a modem. A modem local to computing device 1100 can receive the data on the telephone line and use an Infra-red transmitter to convert the data to an infra-red signal. An infra-red detector coupled to bus 1102 can receive the data carried in the infra-red signal and place the data on bus 1102. Bus 1102 carries the data to memory 1106, from which the processing element 1104 retrieves and executes the instructions. The instructions received by memory 1106 and/or memory 1108 may optionally be stored on storage device 1110 either before or after execution by the processing element 1104.

In accordance with various embodiments, instructions operative to be executed by a processing element to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

This disclosure described some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

What is claimed is:

1. A system for processing fluid containers, the system comprising:
a first tray holder configured to hold a first inlet tray and a first outlet tray, the first inlet tray comprising one or more reservoirs, and the first outlet tray comprising one or more cavities; a couplable upper member comprising a sealing surface;
a moving mechanism configured to move the first tray holder in a first direction so as to bring at least one of the first inlet tray and the first outlet tray in contact with the sealing surface of the couplable upper member; and
a floating plate at least one of between the first outlet tray and a top surface of the moving mechanism, and between the first inlet tray and the top surface of the moving mechanism;
wherein the moving mechanism is configured to independently move the first inlet tray and the first outlet tray in the first direction.

2. The system of claim 1, wherein the first tray holder is a movable tray holder.

3. The system of claim 1, wherein the couplable upper member comprises a cartridge comprising a plurality of capillaries.

4. The system of claim 1, wherein the first direction is a vertical direction along an axis of the couplable upper member.

5. (canceled)

6. The system of claim 1, wherein a pressure applied to the couplable upper member by the moving mechanism via one of the first outlet tray and the first inlet tray is independent from another pressure applied by the moving mechanism to the couplable upper member via the other one of the first outlet tray and the first inlet tray.

7. The system of claim 1, wherein a portion of the first tray holder that is underneath at least one of the first outlet tray and the first inlet tray comprises a cutout so as to expose a bottom portion thereof.

8. The system of claim 1, wherein the moving mechanism is further configured to move the first tray holder in a horizontal direction.

9. The system of claim 1, wherein the moving mechanism comprises at least two independent moving platforms, a first moving platform configured to move the first inlet tray against the bottom surface of the couplable upper member, and a second moving platform configured to move the first outlet tray against the bottom surface of the couplable upper member independently of the first moving platform.

10. The system of claim 1, further comprising:
a second tray holder configured to hold a second inlet tray and a second outlet tray;
the second inlet tray being configured to contain one or more fluid reservoirs; and
the second outlet tray comprising one or more cavities;
wherein the moving mechanism is configured to move the second tray holder in the first direction.

11. The system of claim 10, wherein the second tray holder is a movable second tray holder.

12.-14. (canceled)

15. The system of claim 1, wherein the moving mechanism comprises at least two independent moving platforms, a first moving platform configured to move one of the first inlet tray and the second inlet tray against the bottom surface of the couplable upper member, and a second moving platform configured to move one of the first outlet tray and the second outlet tray against the bottom surface of the couplable upper member independently of the first moving platform.

16. The system of claim 1, wherein the couplable upper member comprises a cartridge comprising a plurality of capillaries, the capillaries being in fluid contact with the reservoirs of the first inlet tray or the second inlet tray and with the cavities of the first outlet tray or the second outlet tray.

17. A method for processing fluid containers, the method comprising:
disposing a first tray holder against a bottom surface of a couplable upper member, the first tray holder holding a first inlet tray and a first outlet tray, the first inlet tray comprising a first fluid in one or more first reservoirs, the first outlet tray comprising a plurality of first cavities, and the couplable upper member comprising a plurality of capillaries;
independently pressing the first inlet tray and the first outlet tray against the bottom surface of the couplable upper member such that the one or more first reservoirs are in fluid communication with a first end of the capillaries and the first cavities are in fluid communication with a second end of the capillaries; and
applying a first force between the first reservoirs and the first cavities to urge at least a portion of the first fluid to transfer from the first reservoirs to the capillaries;
wherein at least one of the first outlet tray and the first inlet tray comprises a first floating plate thereunder, so that independently pressing the first outlet tray and the first inlet tray comprises pressing the first floating plate against a bottom surface thereof to ensure sealing of an interface between the one of the first outlet tray and first inlet tray and the bottom surface of the couplable upper member.

18. The method of claim 17, wherein moving the first tray holder comprises moving the first tray holder in at least one of a horizontal direction and a vertical direction.

19. The method of claim 17, wherein the first tray holder holds the first inlet tray and the first outlet tray in a locked position.

20. The method of claim 17, further comprising transferring the first fluid from the capillaries to the first cavities by applying a second force between the capillaries and the first cavities.

21. The method of claim 17, further comprising:
disposing a second tray holder against the bottom surface of the couplable upper member, the second tray holder holding a second inlet tray and a second outlet tray, the second inlet tray comprising a second fluid in one or more second reservoirs, the second outlet tray comprising a plurality of second cavities;
independently pressing the second inlet tray and the second outlet tray against the bottom surface of the couplable upper member such that the second reservoirs are in fluid communication with a first end of the capillaries and the second cavities are in fluid communication with a second end of the capillaries; and
applying a third force between the second reservoirs and the second cavities so that at least a portion of the second fluid transfers from the second reservoirs to the capillaries;
wherein at least one of the second outlet tray and second inlet tray comprises a second floating plate thereunder, so that independently pressing the second outlet tray and second inlet tray comprises pressing the second flowing plate against a bottom surface thereof to ensure sealing of an interface between the one of the second outlet tray and second inlet tray and the bottom surface of the couplable upper member; and
wherein the first tray holder and the second tray holder are contemporaneously and independently movable with respect to each other.

22. The method of claim 17, further comprising transferring the second fluid from the capillaries to the second cavities by applying a fourth force between the capillaries and the second cavities.

23. The method of claim 17, wherein:
a portion of the first tray holder that is underneath at least one of the first outlet tray and the first inlet tray comprises a cutout so as to expose a bottom portion thereof; and
the first fluid is kept under thermal control via the cutout.

24. The method of claim 23, wherein the thermal control comprises refrigeration of the first fluid.
